(19) United States
(12) Patent Application Publication
(10) Pub. No.: US 2010/0083545 A1
(43) Pub. Date: Apr. 8, 2010

(54) ADVERTISEMENT MEANS FOR SEMITRAILERS AND OTHER MEANS OF TRANSPORTATION

(75) Inventor: JEAN LESSARD, Quebec (CA)

Correspondence Address: Joseph Bain;Novak Druce & Quigg LLP, 525 Okeechobee Blvd, Suite 1500, West Palm Beach, FL, 33401, US

(73) Assignee: CREATION PULSION J.F. INC., Boisbriand (CA)

(21) Appl. No.: 12/535,638

(22) Filed: Aug. 4, 2009

Related U.S. Application Data
(60) Provisional application No. 61/129,977, filed on Aug. 4, 2008.

(51) Int. Cl. G09F 21/04

(52) U.S. Cl. 40/591

(57) ABSTRACT

An advertisement system comprises a visible cover for a merchandise-carrying container of a vehicle, the cover being shaped and/or decorated in association with the merchandise to be contained therein and/or with the advertisement provided on the cover. The cover can include a shell adapted to be mounted to the container of the vehicle. The cover is typically removably mounted to the container. Also, the advertisement system can be embodied in a merchandise-carrying container for a vehicle, the container being shaped and/or decorated in association with the merchandise to be contained therein and/or with the advertisement provided on the container. Furthermore, wraps may be applied on the container with images being provided on the wrap to provide various 3D or 3D-type advertisement effects.

### CROSS REFERENCE TO RELATED APPLICATIONS

This Application claims priority on U.S. Provisional Application No. 61/129,977, filed on Aug. 4, 2008, which is herein incorporated by reference.

### FIELD OF THE INVENTION

The present invention relates to motorized cargo vehicles, such as semitrailers and delivery trucks, and, more particularly, to vehicles having a container adapted to transport merchandise. The present invention also relates to advertisement systems for use on various transportation means.

### BACKGROUND OF THE INVENTION

Delivery vehicles are well known for conveying merchandise between pick-up and delivery sites. Such vehicles include tractor rigs equipped with semitrailers, delivery trucks, train railroad cars, etc. Also known are containers adapted to be loaded on ships, trains and flatbed trucks. Generally, these vehicles include closed containers adapted to carry the merchandise to be conveyed from one site to another.

It is also well known to appose advertisements typically on the side walls of the containers (particularly on the side and rear panels), such as on the semitrailer walls of a tractor rig-semitrailer combination or on the walls of the rear rectangular container of a delivery truck. These advertisements take different forms, including being printed directly on the container panels or on canvases (or any other suitable flexible medium) that are tautly mounted to the container panels.

In this world where advertizing is at every corner and where companies are constantly attempting to develop or to use new means of advertisement, there remains a need for new creative forms of advertizing.

### SUMMARY OF THE INVENTION

It is therefore an aim of the present invention to provide a novel advertising system.

It is also an aim of the present invention to provide a new advertising medium for merchandise containers, including semitrailers, delivery truck containers, cargo containers, train railroad cars, etc.

More specifically, in accordance with the present invention, there is provided an advertisement system, comprising a visible cover for a merchandise-carrying container of a vehicle, the cover being shaped and/or decorated in association with the merchandise to be contained therein and/or with the advertisement provided on the cover.

Also in accordance with the present invention, there is provided an advertisement system, comprising a merchandise-carrying container for a vehicle, the container being shaped and/or decorated in association with the merchandise to be contained therein and/or with the advertisement provided on the container.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIGS. 1 to 5 are various angled views of tractor-rig-semitrailer combinations showing semitrailers each having a shape associated with the merchandise contained therein or with the advertisement provided on the semitrailer, in accordance with illustrative embodiments of the present invention;

FIG. 6 is similar to FIGS. 1 to 5, but shows in a side elevation view another semitrailer shape in accordance with a further illustrative embodiment of the present invention;

FIG. 7 is an angled view of a delivery truck having a shape associated with the merchandise contained therein or with the advertisement provided on the delivery truck, in accordance with a further illustrative embodiment of the present invention;

FIG. 8 is an angled view of a shell of the delivery truck of FIG. 7, a shape of the shell being associated with the merchandise contained therein or with the advertisement provided on the delivery truck's shell;

FIG. 9 is an angled view of a delivery truck decorated with an advertisement system in accordance with a further illustrative embodiment of the present invention;

FIGS. 10 to 13 are various angled views of a delivery truck decorated with an advertisement system in accordance with a further illustrative embodiment of the present invention;

FIG. 14 is an angled view of a semitrailer of a delivery truck decorated with an advertisement system in accordance with a further illustrative embodiment of the present invention; and

FIG. 15 is an angled view of a delivery truck decorated with an advertisement system in accordance with a further illustrative embodiment of the present invention.

### DESCRIPTION OF ILLUSTRATIVE EMBODIMENTS OF THE INVENTION

Turning to the figures of the appended drawings, an advertisement system S according to an embodiment of the present invention will be described.

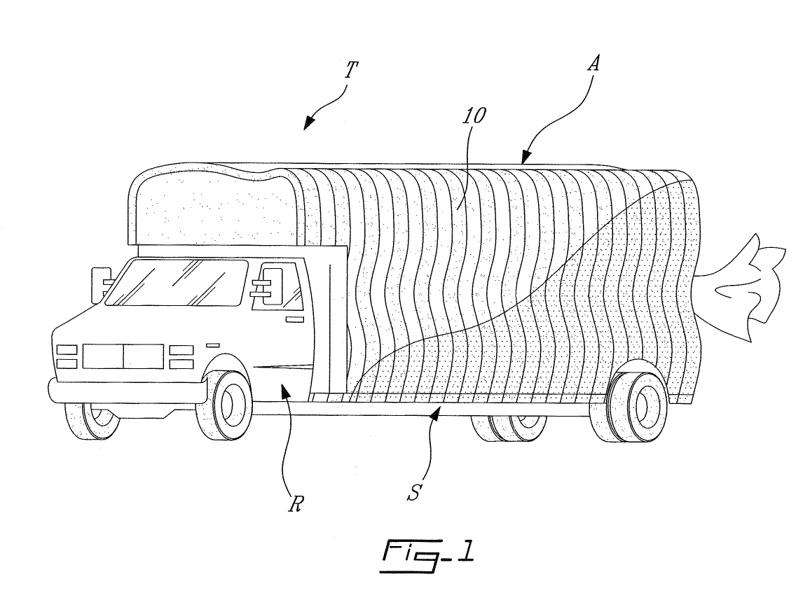

Referring to FIG. 1, the advertisement system A is shown incorporated in a tractor rig-semitrailer combination T that basically includes a tractor rig R and a semitrailer S. The semitrailer S includes a container 10, herein elongated, adapted to carry at least one merchandise to be delivered to a given site. In the illustrative embodiment of FIG. 1, the container 10 has a shape a bread and the outside walls of the container carry advertisement (not shown) for instance identifying a bread make/brand. Therefore, the shape of the container 10 of the semitrailer S is representative of the company being advertised thereby and is further typically linked to the merchandise conveyed in the container 10 or at least to merchandise associated with the company.

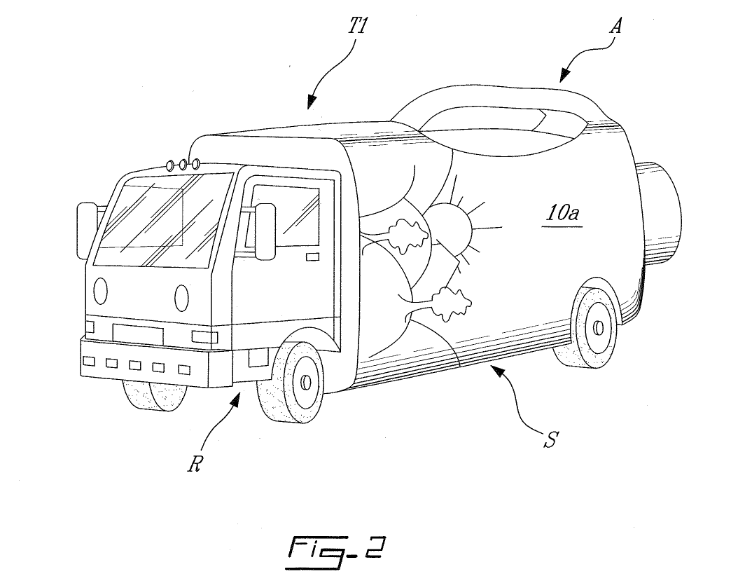

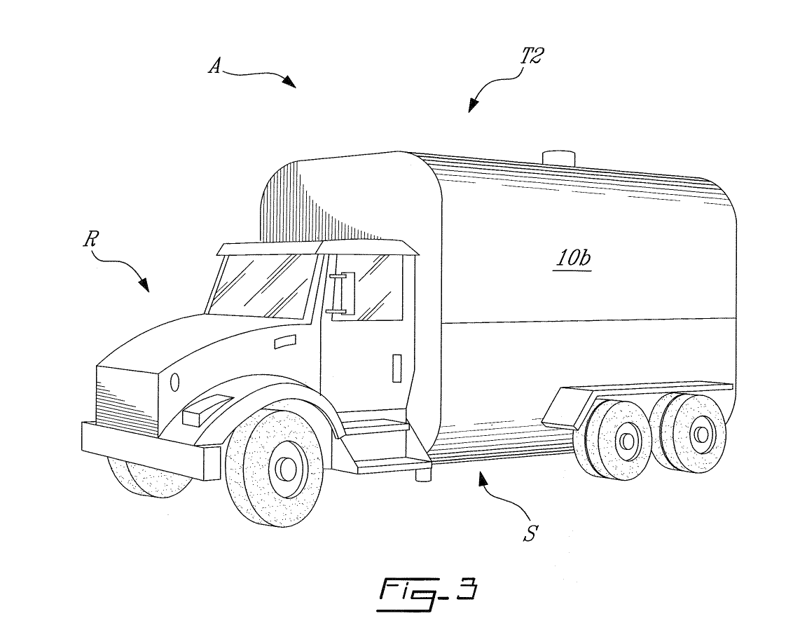

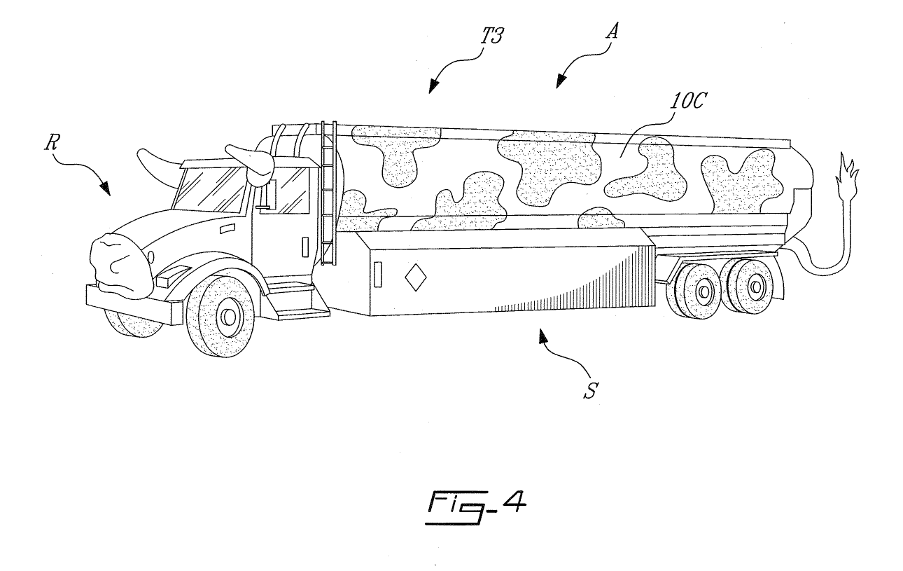

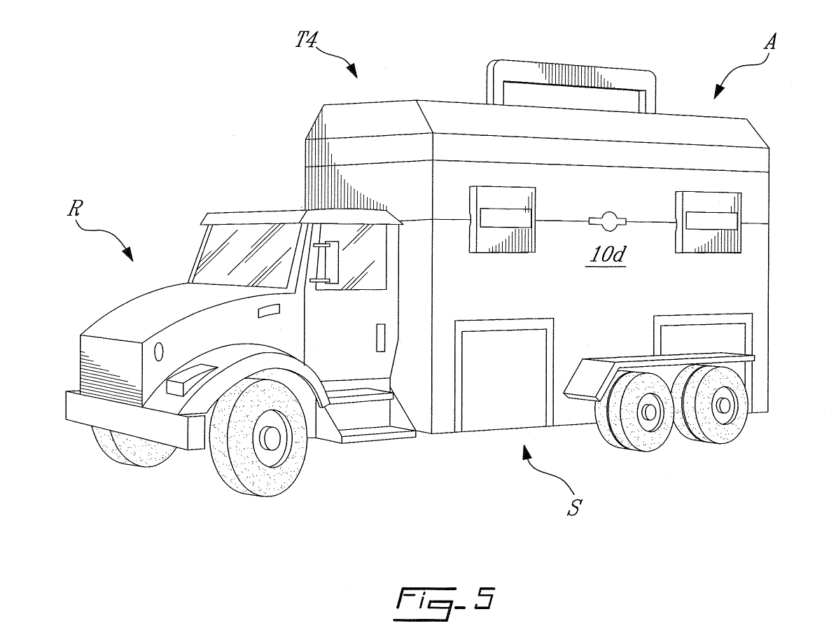

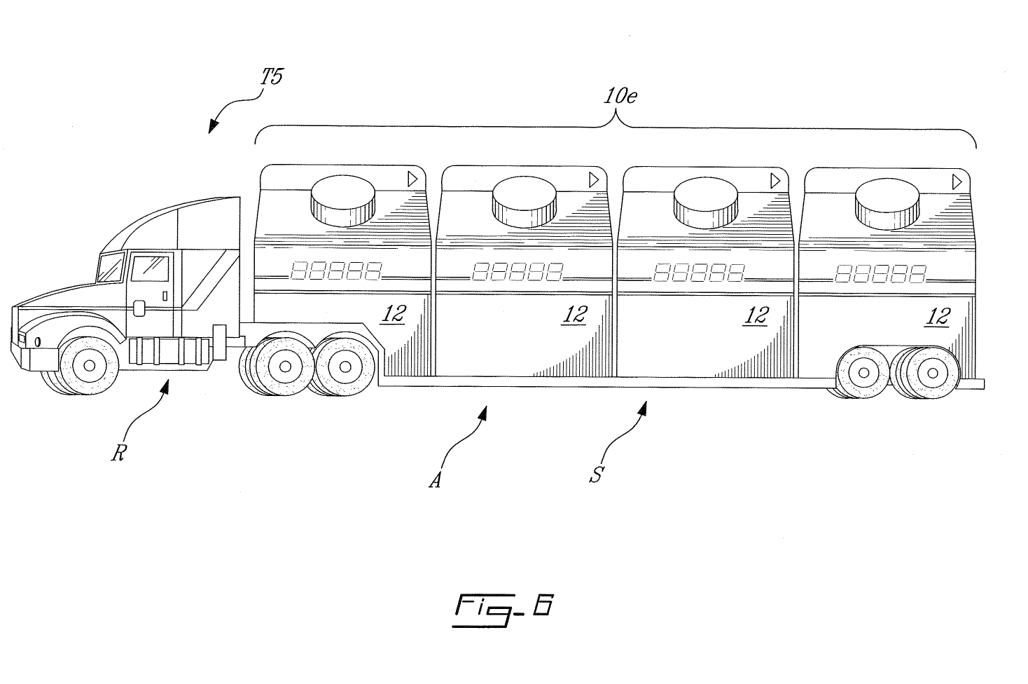

FIGS. 2 to 6 are similar to FIG. 1, except that the tractor rig-semitrailer combinations thereof, identified respectively by references T1, T2, T3, T4 and T5, have respective containers 10a to 10e of different shapes. More specifically, as herein illustrated, the container 10a of FIG. 2 has the shape of a plastic 2-litre milk jug; the container 10b of FIG. 3 has the shape of an oil tank; the container 10c of FIG. 4 is decorated with a cow pattern (for delivery of milk products); the container 10d of FIG. 5 has the shape of a tool box (for advertising, for example, a tool manufacturer or supplier); and the container 10e of FIG. 6 has the shape of a series (herein 4 units) small cardboard milk jugs 12.

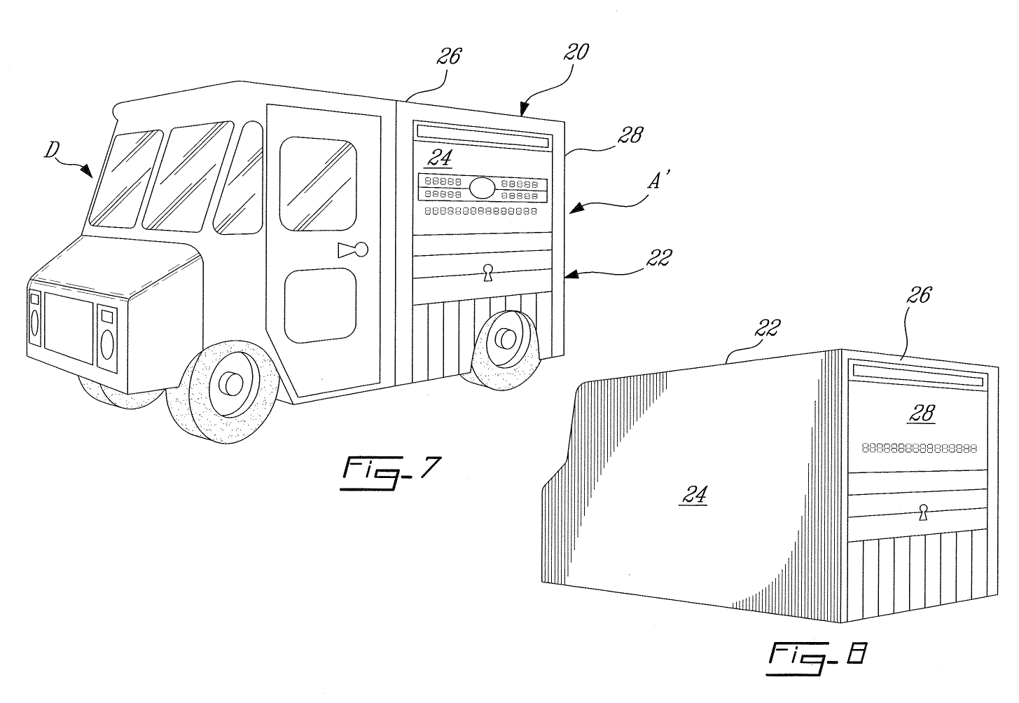

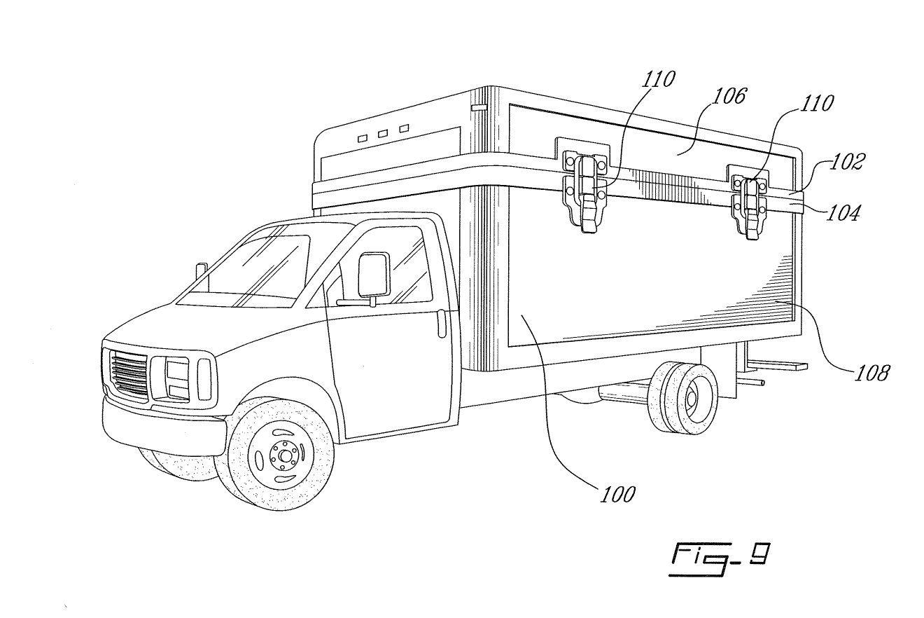

In the illustrative embodiments of FIGS. 1 to 6, the structural walls of the semitrailer containers 10 to 10e are shaped in accordance with the merchandise associated therewith or with the advertisement provided on the containers. Alternatively, as per the illustrative embodiment of FIGS. 7 and 8, herein embodied in a delivery truck D (although the following concept can also be applied to semitrailers), a merchandise-carrying container 20 of the delivery truck D is adjusted with an outer shell 22 that is part of a modified advertisement system A′. The outer shell 22 is shaped in accordance with the merchandise associated therewith or with the advertisement provided thereon. Therefore, the outer shell 22 is mounted on the standard structural container of the delivery truck. Similarly, with reference to the containers 10 to 10e of FIGS. 1 to 6, outer shells in the various desired advertising shapes could be fitted over the standard containers of the semitrailers.

The shell concept of FIGS. 7 and 8 allows for the present advertisement system and A′ to be used on standard containers on semitrailers and delivery trucks without significantly having to modify these containers (except for possible mounting hardware that has to be installed on the standard containers so as to allow the shells to be securely and easily installed thereon). The shell can also be replaced with new shells of different shapes/advertisements.

The shell 22 can be made of one or more parts; for instance, it can be comprised of two side walls 24, a top wall 26 and a rear wall 28; also, the two side walls and top wall can be unitary, forming a three-sided tunnel-shaped unit that can be for example slidably mounted onto the container, with a separate rear wall being possibly mounted thereafter.

The selectively shaped containers 10 to 10e of FIGS. 1 to 6 and of the shell 22 of FIGS. 7 and 8 can be made using various manufacturing methods and using various materials, chosen in accordance with the intended use of the advertising media (structural and decorative as in FIGS. 1 to 6, or decorative only as in FIGS. 7 and 8) and the desired shape. For instance, the containers 10 to 10e of FIGS. 1 to 6 and of the shell 22 of FIGS. 7 and 8 can be molded, in fiberglass.

Various paints and printing techniques may be used depending on the material and the desired effect. For example, decorative paints (“trompe-l'oeil”), patinas, applications of various textures, lacquer, etc.

The shell 22 can be installed via aluminum frames or strips previously anchored to the walls of the structural merchandise-carrying container 20. For instance, the aluminum frames or strips are mounted to the friction bands (5.75 inches) of the container 20, along with outside reinforcement.

The resulting dimensions of the containers 10 to 10e of FIGS. 1 to 6 and of the shell 22 of FIGS. 7 and 8 conform to the transportation industry standards with respect to height, length, width, total load per axle, and total weight when loaded.

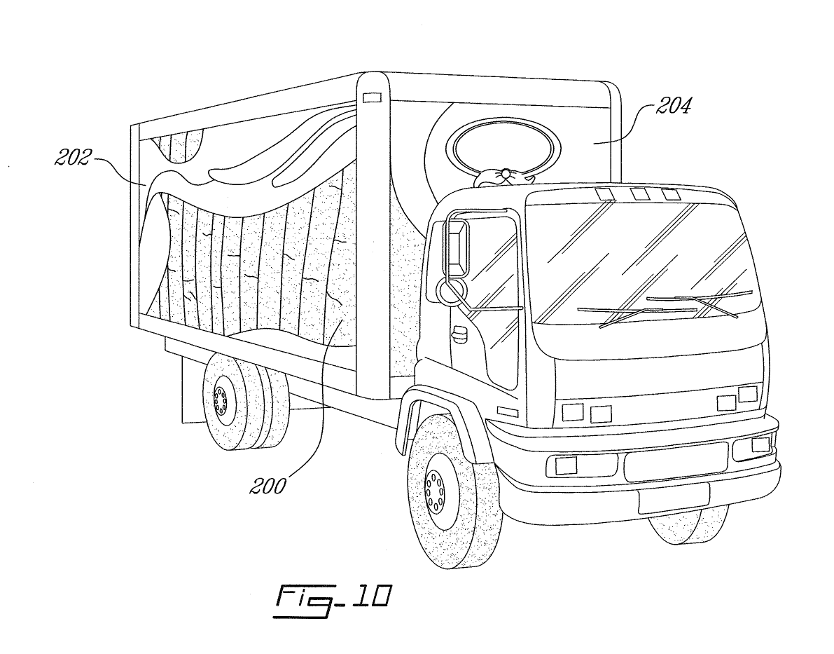

Also in accordance with the present invention, FIGS. 9 to 13 illustrate various other advertisement systems, wherein the containers of the delivery trucks are decorated with a wrap, i.e. a flexible sheathing that is applied on a standard container. An image is printed on the wrap and this image provides the desired advertisement.

For example, in FIG. 9, a wrap 100 has been applied on the container. The image on the wrap 100 is that of a toolbox. The image even provides three-dimensional illusions such as upper and lower ribs 102 and 104 provided where a cover 106 of the toolbox overlies a lower container 108 thereof. The ribs look raised even though they are part of the two-dimensional image. Additionally, a pair of decorative three-dimensional clips 110 are provided on the wrap 100.

In FIGS. 10 to 13, various wraps provided with images have been applied on the containers of the delivery trucks. In these cases, the wraps are provided on at least two adjoining walls of the container and typically the wraps are mounted on both the long side walls of the container and at least one of the front and rear walls thereof. Importantly, in these embodiments, the images of the decorated walls show a complete product from its corresponding sides, such that there is a continuity of the representation of the product from wall to another. In other words and with reference to FIG. 10 for clarity, the images on the wrap 200 illustrate a loaf of bread (in a mostly transparent package), with the images 202 on the long sides of the container showing the loaf of bread from its long sides, whereas the image 204 on the front side of the container shows the loaf of bread from its front end and the image (not shown) on the rear side of the container shows the loaf of bread from its rear end. Therefore, generally the whole product, herein the loaf of bread, is illustrated in 3D fashion using wrap provided with appropriate images of the product.

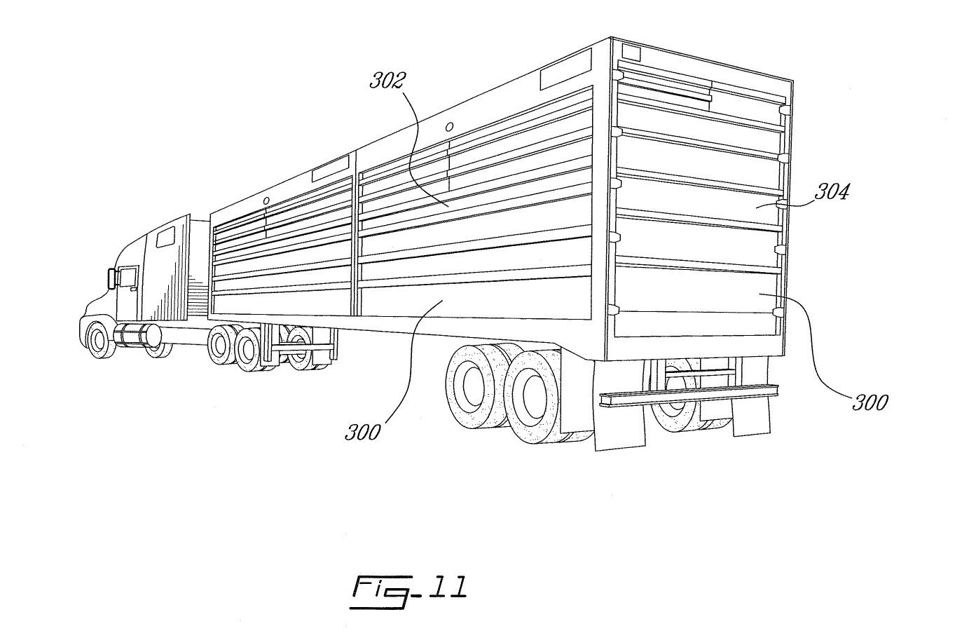

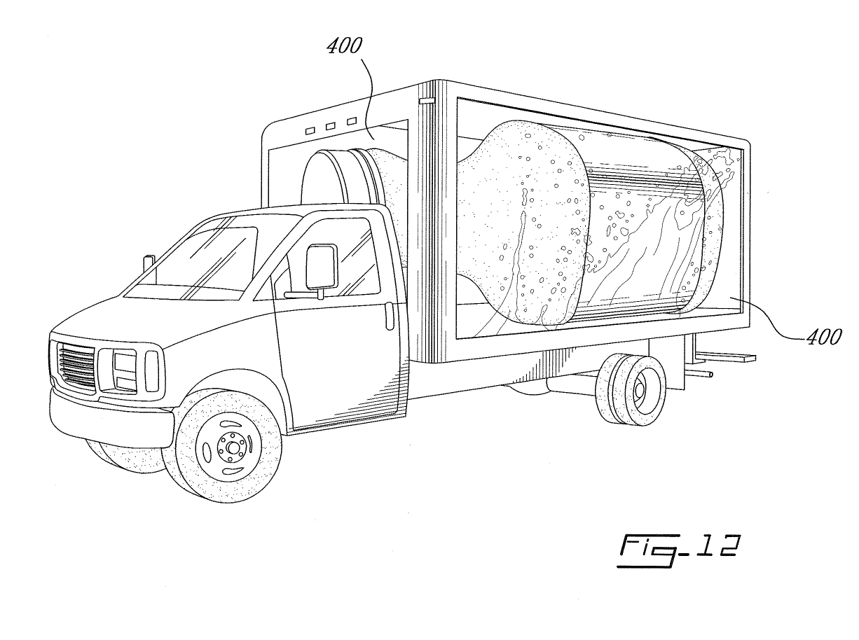

In FIG. 11, the wrap 300 has images that define a toolbox (of the type having multiple drawers) using side images 302 of the toolbox on each long side of the container and a rear image 304 of the toolbox applied on the rear wall of the container. The images 302 and 304 on the three adjoining sides of the container provide a 3D-like representation of the toolbox.

FIGS. 12 and 13 are similar to FIG. 10 in that the wrap 400/500 extends at least along the long sides and front wall of the container such that three images provided on the wrap 400 or 500 provide a 3D-like representation of a spilling juice carton and of a juice bottle in FIGS. 12 and 13 respectively.

FIG. 14 shows the semitrailer S provided with a wrap 600, wherein on the illustrated long side of the semitrailer S, the image 602 is such as to produce a photographic relief, i.e. even though the image is 2D, it appears to show the advertised product (herein a dog bone 604) in 3D. Indeed, in FIG. 14, the semitrailer S seems to be missing its long side, with the bone 604 appearing to be suspended within the semitrailer with clasps 606 and rings 608, the rings 608 appearing to be mounted to the underside of the top wall of the semitrailer S, where in fact the bone 604, the clasps 606 and the rings 608 are all part of a 2D image.

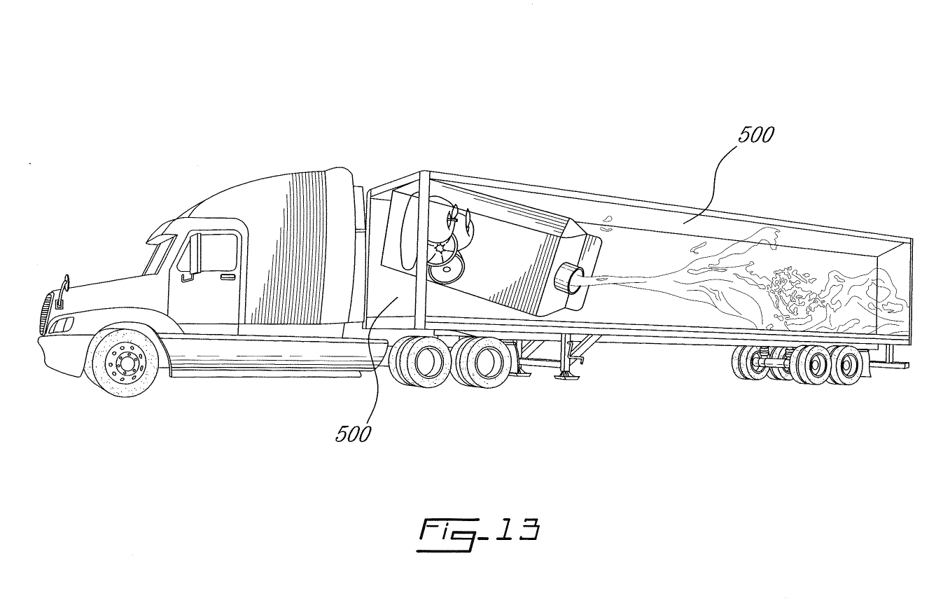

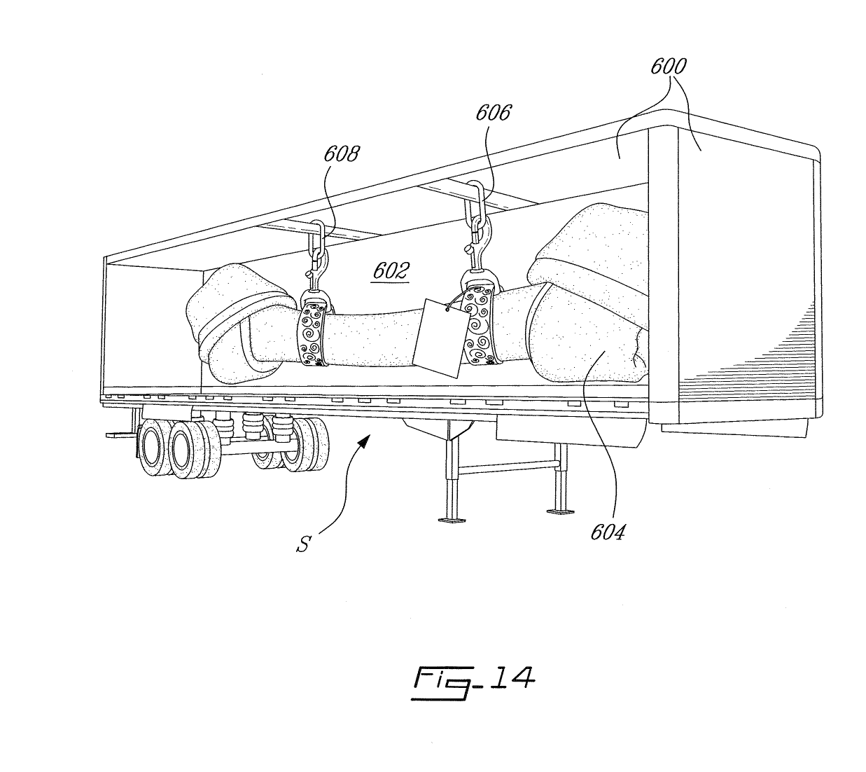

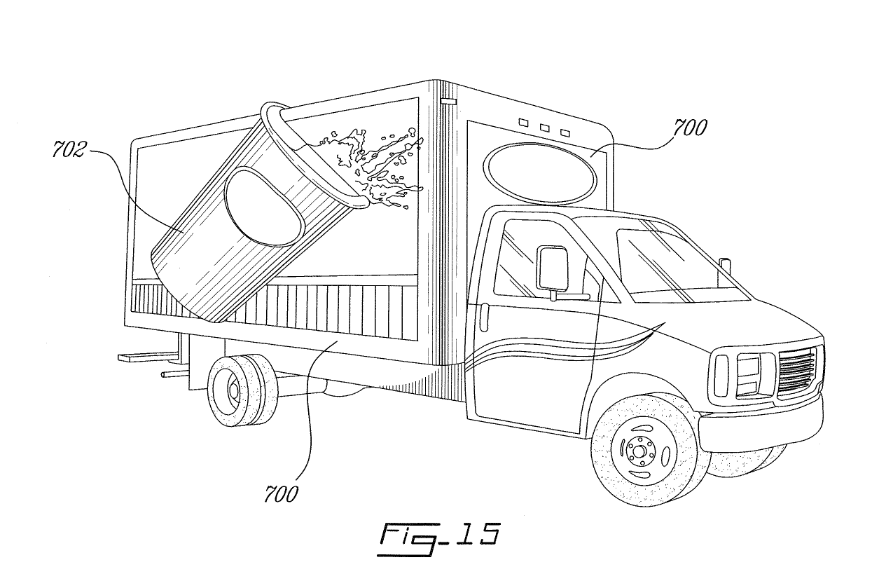

FIG. 15 shows a further embodiment of the present invention, wherein a wrap 700 has been applied on the container of a delivery truck in a way similar to FIG. 9, but with a three-dimensional form 702 having been provided on the long side of the container prior to the wrap 700 having been mounted to the container. Therefore, the form 702 is trapped between the container wall and the wrap 700 and provided a 3D element to the product illustrated on the wrap 700. In this case, the advertisement is for a coffee shop and the form 702 is that of a coffee cup which thus protrudes partly from the container wall.

The present different advertisement systems provide a decorative relief to a delivery container. The container can have a shape adapted to the product being advertised (FIGS. 1 to 8) or a wrap bearing at least one image of the product may be applied on the container (FIGS. 9 to 15). 3D elements can be applied on the wrap (FIG. 9) or under the wrap (FIG. 15). Images provided on at least two consecutive sides of the container can reproduce an advertised product in its 3D state (FIGS. 10 to 13). The 3D effect may be implied, as opposed to being real, as in FIG. 14.

The decoration, which is provided by the images and/or the shape of the container and/or the 3D elements provided on the container, is associated to the company, product or brand advertised on the delivery container, and may be associated with the goods being transported in the container. The present advertisement systems reproduce or illustrate a product such as to identify the contents, the name or the logo of the product.

Additional elements may also be used to further decorate/enhance the advertisement effects provided by the above systems, such as fiber optics, illumination means, paints, etc

The above advertisement systems can be used on various transportation means and not necessarily only on the delivery trucks. For instance, the advertisement systems can be used on ground transportation vehicles, e.g. various types of trucks, automobiles, campers, caravans, etc. They can also be used on public transportation vehicles, e.g. buses, metros, tramways, coaches, trolleys, trains, etc. They can further be used on air transportation, e.g. airplanes, helicopters, etc., and on maritime transportations, e.g. boats, ships, etc. They can still further be used on freight containers, and even on buildings, e.g. restaurants, etc.

Although the present invention has been described hereinabove by way of embodiments thereof, it may be modified, without departing from the nature and teachings of the subject invention as described herein.

1. An advertisement system, comprising a visible cover for a merchandise-carrying container of a transportation means, the cover being shaped and/or decorated in association with the merchandise to be contained therein and/or with the advertisement provided on the cover.

2. The advertisement system of claim 1, wherein the cover includes a shell adapted to be mounted to the container of the vehicle.

3. The advertisement system of claim 2, wherein the cover is removably mounted to the container.

4. An advertisement system, comprising a merchandise-carrying container for a transportation means, the container being shaped and/or decorated in association with the merchandise to be contained therein and/or with the advertisement provided on the container.

5. The advertisement system of claim 3, wherein the cover is slidably mounted to the container.

6. An advertisement system, said advertisement system being adapted to be mounted to a means of transportation and comprising at least one visible cover provided with at least two images, the images being related to the item being advertised.

7. The advertisement system of claim 6, wherein the images illustrate the product from various angles.

8. The advertisement system of claim 6, wherein the cover includes at least two cover sections each having at least one image thereon.

9. The advertisement system of claim 8, wherein the cover sections are mounted on portions of the means of transportation, which are not coplanar.

10. The advertisement system of claim 9, wherein the two images of the two cover sections show the product from two different points of view separated by an angle, and wherein the two portions of the means of transportation extend substantially at said angle.

11. The advertisement system of claim 8, wherein the means of transportation is a container having at least two adjacent or contiguous walls with the two cover sections being arranged on the two container walls in such a way that the two images provide a three-dimensional representation of the product.

12. The advertisement system of claim 11, wherein there are at least three cover sections each displaying at least one image and being adapted to be applied to three adjacent or contiguous walls of the container.

13. The advertisement system of claim 12, wherein each image shows a side of the product and wherein the images are positioned to provide a three-dimensional representation of the product.

14. The advertisement system of claim 6, wherein said visible cover comprises a wrap.

15. The advertisement system of claim 6, wherein a form is adapted to be positioned between the cover and the means of transportation such as to provide a three-dimensional relief protruding from the means of transportation.

16. The advertisement system of claim 6, wherein at least one decorative element is provided on the means of transportation and is positioned so as to complement the images in illustrating the product.

17. The advertisement system of claim 16, wherein the decorative element provides a three-dimensional relief protruding from the means of transportation.

18. An advertisement system, said advertisement system being adapted to be mounted to a surface of a means of transportation and comprising at least one visible cover provided with at least one image related to the item being advertised, wherein said image provides a three-dimensional representation of the item.

19. The advertisement system of claim 18, wherein the image is adapted to produce a photographic relief of the item shown thereby, whereby the item appears in three-dimensional attitude.

20. The advertisement system of claim 18, wherein the means of transportation is a container having at least a wall suitable to receive thereon the cover.
